(19) United States
(12) Patent Application Publication
(10) Pub. No.: US 2019/0303115 A1
(43) Pub. Date: Oct. 3, 2019

(54) AUTOMATED SOURCE CODE SAMPLE ADAPTATION

(71) Applicant: CA, Inc., Islandia, NY (US)

(72) Inventors: Ian Aloysious Kelly, Colleyville, TX (US); Peter Ian Oliveira, Fountain Hills (US)

(73) Assignee: CA, Inc., Islandia, NY (US)

(21) Appl. No.: 15/941,329

(22) Filed: Mar. 30, 2018

(51) Int. Cl. G06F 8/41; G06F 21/53; G06F 8/30; H04L 29/08

(52) U.S. Cl. CPC G06F 8/433; H04L 67/02; G06F 8/31; G06F 21/53

(57) ABSTRACT

A current context is determined for use of a software development tool by a user during a particular time. The current context includes attributes of a particular software coding project, and the software development tool is used to edit the particular software coding project during the particular time. A webpage is identified for presentation in a web browser and a segment of sample source code is detected within content of the webpage. Values are determined in the segment of sample source code corresponding to the attributes of the particular software coding project. The values in the segment of sample source code are autonomously replaced with project-specific values to cause a project-specific version of the segment of sample source code to be presented in the webpage during a session corresponding to the particular time, the project-specific values based on the attributes of the particular software coding project.

### BACKGROUND

The present disclosure relates in general to the field of computer development, and more specifically, to computing systems autonomously modifying source code samples based on detected activity within an integrated development environment tool.

Modern software systems often include multiple programs or applications working together to accomplish a task or deliver a result. For instance, a first program can provide a front end with graphical user interfaces with which a user is to interact. The first program can consume services of a second program, including resources of one or more databases, or other programs or data structures. Software programs may be written in any one of a variety of programming languages, with programs consisting of software components written in source code according to one or more of these languages. Development environments exist for producing, managing and compiling these programs. For instance, an integrated development environment, or “IDE,” may be used which includes a set of integrated programming tools such as code editors, compilers, linkers, and debuggers.

### BRIEF SUMMARY

According to one aspect of the present disclosure, a current context may be determined for use of a software development tool by a user during a particular time. The current context may include attributes of a particular software coding project, and the software development tool may be used to edit the particular software coding project during the particular time. A webpage may be identified for presentation in a web browser and a segment of sample source code is detected within content of the webpage. Values may be determined in the segment of sample source code corresponding to the attributes of the particular software coding project. The values in the segment of sample source code may be autonomously replaced with project-specific values to cause a project-specific version of the segment of sample source code to be presented in the webpage during a session corresponding to the particular time, the project-specific values based on the attributes of the particular software coding project.

### BRIEF DESCRIPTION OF THE DRAWINGS

FIG. 1 is a simplified schematic diagram of an example computing system including an example software development system in accordance with at least one embodiment;

FIG. 2 is a simplified block diagram of an example computing system including an example software development system and repository system in accordance with at least one embodiment;

FIG. 3 is a simplified block diagram illustrating project-based adaptation of code samples in accordance with at least one embodiment;

FIGS. 4A-4D are simplified block diagrams illustrating example adaptations of code samples to generate project-specific versions of the code samples in accordance with at least some embodiments;

FIG. 5 is a block diagram illustrating example generation of a sandbox execution environment to test execution of a corresponding code sample in accordance with at least some embodiments;

FIGS. 6A-6B are simplified flowcharts illustrating example techniques for enhancing code samples for presentation to users in graphical user interfaces in accordance with at least some embodiments.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “ module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

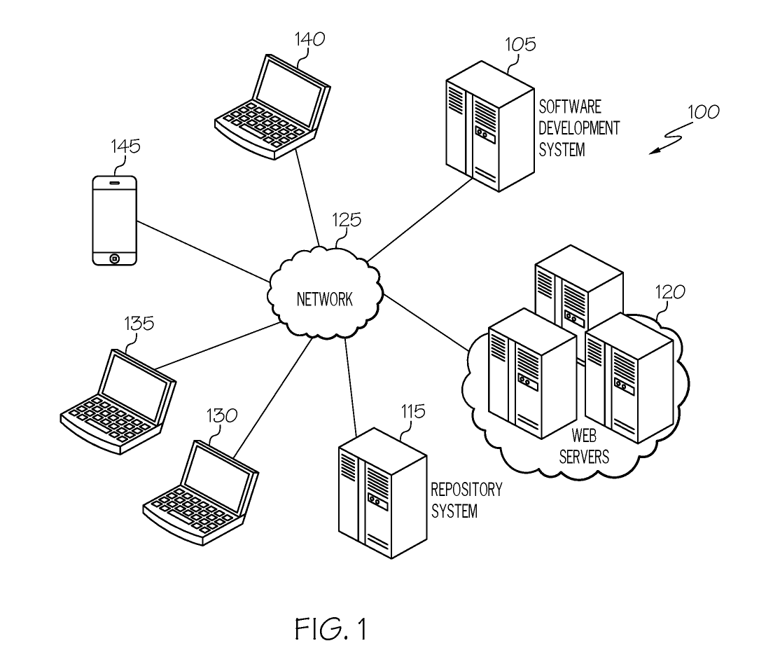

Referring now to FIG. 1, a simplified block diagram is shown illustrating an example computing environment 100 including an example software development system 105, which may host an integrated development environment (IDE) including a source code editor to allow user-developers to draft code to implement various software programs. In some implementations, the software development system 105 may be equipped with enhanced logic, implemented in hardware and/or software, to autonomously mine code and metadata of other software coding projects to intelligently provide project-specific guidance to the developer to assist them in understanding opportunities to improve their code and resulting projects.

In some implementations, an example system 100 may further include repository systems (e.g., 115), such as a software configuration management (SCM) repository system. Repository systems may include repositories which are public, such that the repositories provide open source or shared software components together with management of changes within these components. An example repository system (e.g., 115) may also host and manage private repositories, such as an enterprise repository system or repository for a particular software development firm (e.g., to balance the privacy of the code being developed by such an enterprise (which may be of extreme importance) with developer collaboration within the enterprise through the repository system). In some implementations, the repositories hosted by an example repository system 115 may include a wealth of other coding projects and related metadata, which may be used by an example software development system 105 to guide the development of new coding projects and modification of existing coding projects, among other example uses. For instance, data from other coding projects may be used to determine patterns among groups of coding projects. These patterns may be used to generate suggested outlines for new coding projects. Information from other coding projects may also be leveraged to autonomously customize source code samples (e.g., provided by third party sources (e.g., web servers 120)) to a particular project being editing using an example IDE (e.g., provided by software development system 105), among other examples. In some instances, the software development system (e.g., 105) may be combined with a repository system (e.g., 115) such that the software development system interface directly with the repository system (e.g., in support of enhanced software development functionality provided through the software development system) and provide source code editing tools in connection with repositories of the repository system, among other example implementations.

An example system may further include a variety of other server systems (e.g., 120) hosting various resources that may be accessed and consumed using other computing systems (e.g., 105, 115, 130, 135, 140, 145, etc.). For instance, web servers 120 may be embodied as various computing systems connected to one or more networks (e.g., 125), which may host various applications, web pages, services, data, and other resources. In some cases, web servers 120 may host blogs, online training materials, and other web pages, which may include source code examples and other information that developer-users may access to educate and guide them in their respective coding projects, peer reviews, etc. Developer-users (or simply “users” or “developers”) may utilize various user devices (e.g., 130, 135, 140, 145) to connect to one or more networks (e.g., 125) and access resources hosted by various server systems (e.g., 120). Indeed, user devices (e.g., 130, 135, 140, 145) may be additionally used to access data, services, and resources including those hosted by example enhanced software development systems (e.g., 105, example repository systems (e.g., 115), among other examples. In some instances, the user devices (e.g., 130, 135, 140, 145) may also be used to provide data to remote services and systems (e.g., over networks (e.g., 125)). For instance, client devices (e.g., 130, 135, 140, 145) may also interface with repository systems (e.g., 110, 115) to provide various source code components (e.g., projects, applications, branches, etc.) for inclusion or updates to repositories hosted by the repository systems, among other examples. In some cases, a web browser or other platform provided on a user device (e.g., 130, 135, 140, 145) may be used to interface with, execute, or otherwise use resources provided by other systems (e.g., 105, 115, 120) communicatively coupled to the user devices over one or more networks (e.g., 125). Networks (e.g., 125) within the system 100 may include private and/or public networks including wireless and/or wireline networks facilitated using various network technologies and topologies.

In general, “servers,” “clients,” “computing devices,” “network elements,” “database systems,” “user devices,” and “systems,” etc. (e.g., 105, 115, 120, 130, 135, 140, 145, etc.) in example computing environment 100, can include electronic computing devices operable to receive, transmit, process, store, or manage data and information associated with the computing environment 100. As used in this document, the term “data processing apparatus,” “computer,” “processor,” “processor device,” or “processing device” is intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 115, 120, 130, 135, 140, 145, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, an enhanced software development system 105, repository systems (e.g., 115), web server systems (e.g., 120), or other sub-system of computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Modern software development may involve the cooperation of a team of developers working on respective portions of a larger software system. Further, it is becoming increasingly common for developers to rely on code components found in shared code libraries and include these components within their own projects and applications to provide objects, methods, functions, etc. for use in their projects without having to develop analogous components with similar functionality. Given these and other example trends, it is becoming increasingly difficult for individual developers and even teams of developers to understand the complex interconnections and underlying code within their own projects. Further, it is becoming increasingly common for users to rely on, include, or take inspiration from pieces of codes and related projects authored by others and of which the user has little familiarity. In such cases, developers may underappreciate the potential consequences and risks associated with relying on or using code and information provided by other users and entities, among other example issues.

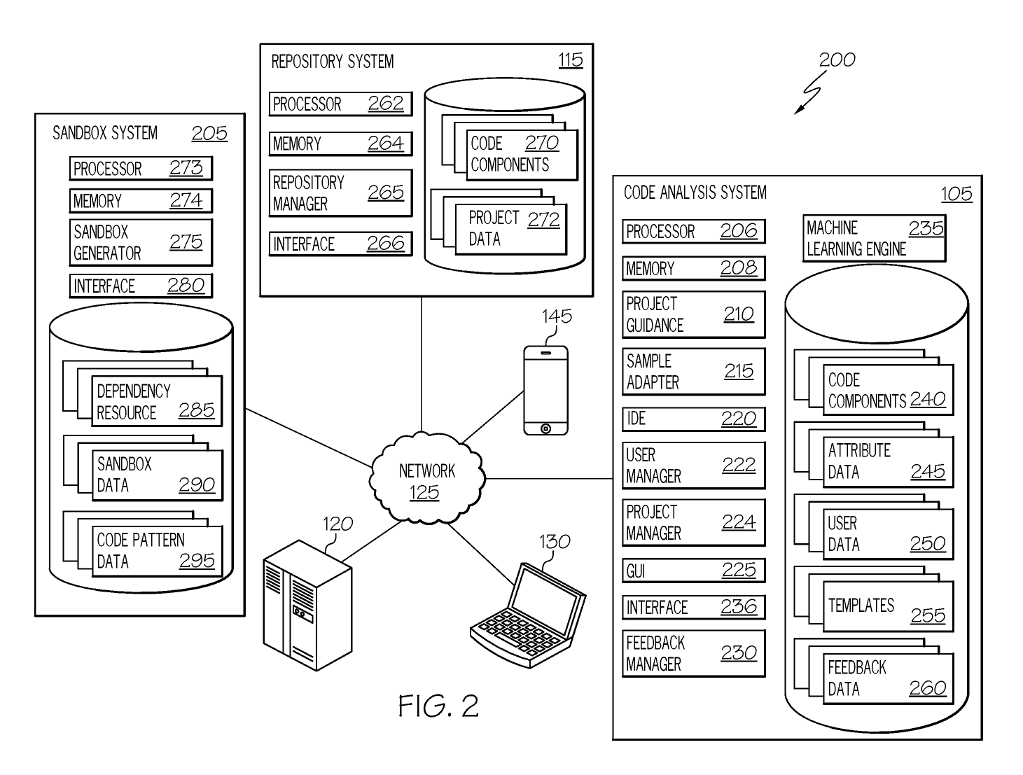

At least some of the systems described in the present disclosure, such as the systems of FIGS. 1 and 2, can include functionality to at least partially address at least some of the above-discussed issues, as well as others not explicitly described. For instance, a simplified block diagram 200 is shown illustrating an example environment including an enhanced implementation of an example software development system 105. The environment may additionally include repository system (e.g., 115), one or more web servers, sandbox system (e.g., 205), among other example systems. An example software development system 105 may include one or more data processing apparatus (e.g., 206) and one or more memory elements (e.g., 208) for use in implementing executable modules, such as a project guidance engine 210, coding template generator 212, a code sample adapter 215, integrated development environment (IDE) 220, a user or account manager 222, project manager 224, graphical user interface (GUI) engine 225, user feedback manager 230, among other example components. In some implementations, an enhanced software development system 105 may include or have access to one or more machine learning engines (e.g., 235) (which may include specialized machine learning hardware, such as a tensor processing unit, matrix processing unit, specialized graphics processing unit, among other examples), which may be utilized to perform various machine learning algorithms, using example machine learning models (e.g., neural network models, random forest models, support vector machine (SVM) models, etc.) in connection with and/or to enable functionality of one or more of the components (e.g., 210, 212, 215, 230, etc.) of the enhanced software development system 105, among other examples.

Components of an enhanced software development system 105 may be used to enhance the core software development functionality and tools of the system 105. For instance, core software development functionality may be facilitated through an IDE 220. The IDE 220 may provide functionality such as would be included in a traditional IDE. For instance, the IDE 205 may include a source code editor, build automation tools, a debugger, etc. and may include functionality such as code completion, object and class browsers, syntax highlighting and guides, among other example features. A graphical user interface (GUI) engine 225 may be provided to provide GUIs in connection with the IDE (e.g., a source code editor GUI) as well as other components (e.g., project guidance engine 210) of the software development system. Some components may interface with and track activity of various GUIs offered through the software development system (e.g., using GUI engine 225), so as to identify a project, code component, user behaviors, and other information pertaining to the present context of the software development system's use by a user. Such functionality and information may be leveraged to autonomously provide assistance to the user in improving and completing coding projects using the enhanced software development system (e.g., 105), among other example features and benefits.

In one example implementation, an example enhanced software system 105 may include a project guidance engine 210. In one example, a project guidance engine 210 may include logic, implemented in hardware circuitry (e.g., logic circuits) and/or software, to provide content to a GUI window for display with a source code editor GUI window of the software development system 105. More particularly, the project guidance engine 210 may provide suggestions, for display within the GUI window, that are specifically and dynamically adapted to the code entered by a particular user within the source code editor GUI for a particular coding project (e.g., an application or part of an application, code module, or other component of source code developed using the software development system 105). Accordingly, the project guidance engine 210 may track and continuously analyze code as it is modified within a project using the software development system 105 and determine similarities between the code, as it is entered, with one or more coding project templates 255, which may define a pattern of code within particular categories of projects. The various categories of the projects may be defined based on commonalities identified within groups of coding projects (e.g., within code components 240, 270), for instance, by a template generator 212. The template generator 212 may identify coding patterns within these groupings of similar code and generate respective coding project templates 255 based on these patterns. The coding project templates 255 may describe or outline these patterns and may identify the progression of code within these categories of code, for instance, as a set of steps, as pseudocode (e.g., to capture that the categories of code, although potentially written in different programming languages, may be structurally and functionally similar), and/or actual code examples. The templates 255 may thus provide information to guide developers as they write code in projects similar to these categories of project. Indeed, the project guidance engine 210 may identify a probability that the code in a particular project is similar to and corresponds to a certain category of coding projects, and may further identify the current progress of the user in developing this particular project to provide suggestions for the next line or lines of code based on a corresponding template. This suggestion information may be presented within the GUI window presented with the source code editor do as to provide the developer with an intelligence guide during coding, among other example features.

An enhanced software development system 3.05 may additionally include a code sample adapter 215 to further (or alternatively) assist users as they develop code within a particular coding project. For instance, a code sample adapter 215 may monitor code being edited using an example IDE 220 of the software development system 105 (e.g., edited in a corresponding source code editor) and may likewise obtain information regarding the user (e.g., from user data 250 generated and managed by user manager 222) and additional project-related metadata (e.g., encapsulated in project attribute data and other data, such as managed and generated by a project manager engine 224) to autonomously determine the current project being worked on by the user and the more generalized preferences of the user. The code sample adapter 215 may, at the same time, also monitor web pages and electronic documents accessed by the user contemporaneously with (e.g., at or near (i.e., before or after) the time of the) user's use of a source code editor to edit a particular project to autonomously determine the likely context of the user's access and perusal of these web pages or other electronic documents (e.g., word processor files, Portable Document Format (PDF) documents, etc.). The code sample adapter 215 may scan these electronic documents as they are accessed by the user to detect whether the electronic document includes code samples, such as example code offered by an author of the document to demonstrate how certain functionality may be implemented within the particular coding project using source code). The code sample adapter 215 may identify one or more values within the code (e.g., based on analysis and mining of other code components (e.g., 240, 270)) that tend to vary on a project- or system-specific basis, or based on certain tendencies or preferences of the user implementing similar code. Accordingly, the code sample adapter 215 may autonomously identify, from the determined context of the user's access of this document, substitute values based on project attribute data 245, user data 250, and other information accessible by the code sample adapter 215 describing attributes of the user's project. The code sample adapter 215 may then cause the identified values to be masked or replaced by the substitute values during presentation of the electronic document to the user. In this manner, the code samples within the document may be adapted specifically, and dynamically, to the user's own project, making the samples more relevant, understandable, and easier to implement within the user's own code, among other example benefits.

Components within an example software development system 105 may autonomously predict what information and content (e.g., guidance suggestions generated by a project guidance engine 210 or adapted code samples generated by a code sample adapter 215) is relevant to a particular user based on the code they enter in connection with a particular coding project. In some cases, these predictions, and the resulting data delivered by these components (e.g., 210, 215) may be flawed and of diminished relevance. In some cases, components may accept human supervision to tune their autonomous functionality. For instance, user feedback may be provided in connection with suggestions or customized code samples. The components may then analyze and consider this feedback (e.g., as collected and managed using a feedback manager component 230 and feedback data 260) in future predictions performed by the components (e.g., 210, 212, 215) to make the components progressively more accurate. In some cases, components may be built upon machine learning models, which may include supervised learning models and training sets, which may be supplemented by feedback data 260, among other example uses.

An example software development system 105 may include one or more interfaces (e.g., 236), such as application programming interfaces (APIs) and other interfaces to communicate data between the software development system 105 and one or more other systems (e.g., repository system 115, sandbox system 205, etc.). It should be appreciated that the example software development system 105 illustrated in FIG. 2 may, in other alternative embodiments, be implemented as multiple, distinct systems to provide various sub-combinations of the components shown in the example of FIG. 105. For instance, a template generator 212, in some implementations, may be provided through a separate system, which interfaces with a software development system through one or more APIs (e.g., 236), among other examples (such as examples where a project guidance engine 210 and code sample adapter 215 are provided in separate systems).

In one example, an example sandbox system 205 may be provided, for instance, to supplement functionality and services provided through an example code sample adapter 215. Indeed, in some implementations, a code sample adapter 215 may be provided together with a sandbox system (e.g., in the same or otherwise related systems). In one example, a sandbox system may include one or more data processing apparatus (e.g., 273) and one or more memory elements (e.g., 274) for use in implementing executable modules, such as a sandbox generator 275. The sandbox system 205 may additionally include other components, such as an interface (e.g., 280) to communicate and provide and consumer resources with other systems (e.g., a software development system 105 and repository system 115), among other example components and functionality. In one example, a sandbox generator 275 may be utilized to generate a sandbox execution environment in which a code sample (e.g., selected by a user for sandboxing in connection with presentation of the code sample to the user in a corresponding electronic document) may be executed. For instance, a request to execute a code sample presented in an electronic document, including samples modified by a code sample adapter 215 to reflect project-specific values (e.g., syntax, language, variable values, etc.), may be received by the sandbox generator 275. The sandbox generator 275 may access information (e.g., code pattern data 290) relating to similar uses of similar code within other coding projects to determine a set of dependencies that are to be included within a system in order to successfully execute the code. For instance, a pattern may be determined in code pattern data 295 showing that the use of segments of code similar to the sample code appear to be predicated on the presence of various dependencies (e.g., other software and/or hardware resources, such as a server platform, database, other objects or methods, pre-defined variables, etc.). Such dependencies, in some implementations, may manifest in categories such as environmental dependencies (e.g., network, machine names, directory locations and names, processes, etc.), APIs and libraries (e.g., interface, version, function, etc.), and data dependencies.

In some implementations, a sandbox generator 275 (or another supporting component, such as a component of a corresponding software development system (e.g., 105)) may autonomously determine the set of dependencies corresponding to successful execution of the sample code. The sandbox system 205 may provide or obtain dependency resources 285, which the sandbox generator 275 may use to implement a sandbox environment that includes an identified set of dependencies. For instance, the sandbox generator 275 may autonomously prepare and instantiate a sandbox execution environment with the determined set of dependencies (e.g., selected from dependency resources 285). The sample code may then be run within the sandbox execution environment to allow a user to safely test and observe execution of the sample code in order to better understand whether to include the sample within the user's own project, among other example benefits. For instance, in connection with the execution of the sample code in the sandbox environment, a GUI or GUI window may be presented to the user outlining and describing attributes of the step-by-step execution of the sample, allowing the user to track the status of variables and execution of each instruction, among other example information. In some cases, the GUI may be incorporated with a project editor GUI to allow a user/developer to edit a corresponding project in connection with the test execution using the sandbox, among other example implementations. In some cases, a sandbox system 205 may save configurations of previously generated sandbox environments (e.g., as sandbox data 290) for later use (e.g., to reuse to run the same sample at another instance or to use as basis for generating other sandbox environments), among other examples

Information concerning other coding projects may be obtained, at least partially, from outside systems. In some cases, repository systems (e.g., 115) may be accessed in order to obtain information regarding other coding projects in order to guide a user's development of a particular coding project (e.g., using software development system 105). In some implementations, a repository system 115 may be combined with and enhanced by functionality provided through other systems, such as the example software development system 105 and sandbox system 205 shown and discussed in the example of FIG. 2. In some implementations, an example repository system (e.g., 115) may include one or more data processing apparatus (e.g., 262) and one or more memory elements (e.g., 264) for use in implementing executable modules, such as repository manager 265, and other examples. An example repository manager 265 may possess functionality to define and maintain repositories to track the development and changes to various code segments or components. For instance, a repository may be developed for each of several projects, with copies of the project code being stored together with modified versions of the code and other information to track changes, including proposed, rejected, accepted, and rolled-back changes to the project. In the example shown in FIG. 2, such project change information can be embodied in project data 272 along with other information (e.g., information describing the type of the project, the authors of the project, progress of the project, etc.) collected and generated by the repository manager 265 in connection with its management of the development and implementation of various code components 270 managed using repositories hosted by the repository system 115.

In some implementations, an example repository system (e.g., 115) may enable social collaboration between developers using the repository system 115. For instance, as changes to a project (or source code component) are made, they may be proposed for adoption. This may trigger a workflow, managed by the repository system 115 where other users provide feedback regarding the proposed change. Accordingly, such user feedback and commentary may be generated to document the thoughts, feedback, and commentary of various users relating to particular code components, as well as the rejection, adoption, or rollback of changes in various code component projects. Such information may be accessed and used (e.g., by project guidance engine 210, template generator 212, sample adapter 215, sandbox generator 275, etc.) to determine attributes and similarities between code components. For instance, natural language processing may be used to interpret the information (in project data 272) and determine functionality, the intended purposes, and other attributes of various code components, among other examples.

It should be appreciated that the example system configuration(s) illustrated in FIG. 2 are but one example implementation. Various other alternative designs may be adopted without deviating from the general principles discussed herein. As examples, in some implementations, two or more (or all) of software development system 105, repository system 115, and sandbox system 205 may be implemented in a single system, combining and integrating the functionality of each within a single system. Logical and functional blocks discussed as being implemented in a particular one of the example software development system 105, repository system 115, or sandbox system 205 may be alternatively implemented in another one of the systems. Likewise, example data illustrated as managed in one system may be alternatively maintained and generated in another one of the example systems. As an example, templates (e.g., 255), dependency resources (e.g., 285), source code sample documents, and other data may be maintained in other systems rather than or in addition to the systems illustrated in the example of FIG. 2, among other example alternatives and implementations.

It is common for source code sample to be provided in various electronic publications, such as webpages, blogs, presentations, online tutorials, and other electronic documents. A sample of source code may represent a particular segment of code within a larger code component to facilitate particular functionality or a particular code structure. Given the wide variety of programming languages, programming styles, and system configurations on which code may be developed and deployed, a single particular source code sample may only be adapted for adoption in a small sliver of the potential implementations. It may be considered impractical (and, in some cases, impossible) to manually draft and publish separate versions of the same code sample adapted to every possible programming language, style, and/or system on which the corresponding code may be deployed. As a result, current code samples available online or in other computer systems may be of limited value to users developing projects with attributes different from those assumed by the author of the code sample. This may be particularly troublesome given that code samples are often utilized as aids for less experienced programmers, who may lack the skill and experience to translate, on their own, a presented code sample into code that is adapted for their specific project, among other example issues.

Some code sample producers have attempted to address these and other issues by highlighting, within their samples, the values within the sample may be variable and dependent on the project or system implementation or even the programming language used. In some implementations, code samples may be generated in a markdown or markup language to designate the code samples within a larger document (e.g., a webpage with non-sample text describing the sample or providing other commentary) and potentially also designate those values within the code sample which are likely to vary implementation-to-implementation. Predesignating variable values within the code sample during the authoring of the code sample may potentially assist users in developing corresponding logic, which may be capable of parsing the markdown sample to automatically variable values within the sample and map their own system- or project-specific values to these predesignated fields integrated within the code sample to allow users possessing such logic to customize these pre-enabled code samples to their respective projects. However, standardizing a markdown format, for example, to specially designated variable fields within code samples may require both the universal standardization of the format and the disciplined compliance by code sample authors with these standards to ensure that such a solution would be applicable across what can be a vast and varied collection of code samples provided in a wide variety of electronic documents (to say nothing of the need to retrofit code samples generated before the definition of the standardized format). Such global standardization of a definition for code sample formats may be unworkable, given the considerations above, with defined code sample formats likely only providing the possibility of project-specific code sample adaptation to be enabled for the potentially small subset of code samples, which are authored (or retrofitted) in the standardized markdown language, among other example issues.

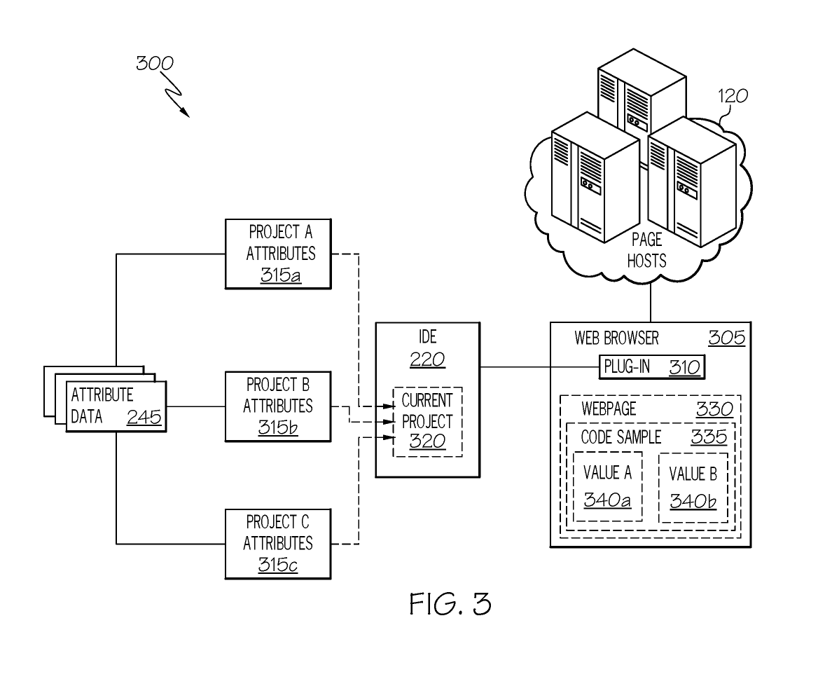

In some implementations, machine learning and artificial intelligence, as well other computer system logic implementing autonomous code analysis and comparison by a computer system, may be utilized to both detect source code examples within electronic documents (and even multimedia presentations), as well as determine which code within the source code sample may be varied depending on the project or system to which the code is applied. Further, an example code sample adapter may automate the generation of an augmented, project-specific version of the code sample by accessing and using project attribute data for the corresponding project. For instance, in the example of FIG. 3, a simplified block diagram 300 is shown illustrating the example project-based adaptation of code samples, which may be performed autonomously be an enhanced software development system (e.g., using an example code sample adapter).

In some implementations, attribute data 245 may be generated in connection with the development of a given coding project. Attribute data 245 may also be generated to describe historical code development by a particular user, team of users, or organization. Such generalized attribute information may be combined with project-specific attribute information to develop data (e.g., 315a-c) describing project-specific attributes for each one of multiple projects developed by a user, group of users, or organization, or even multiple projects developed by multiple, different, unaffiliated users (e.g., for different corresponding projects developed in connection with repositories offered through an example repository system), among other examples.

A software development system may provide an IDE 220 and other software development tools, which may include source code editors and other tools. The source code of any one of multiple different coding projects may be created, edited, or otherwise modified using the IDE 220. The IDE 220 may include an interface to a web browser or other document presentation tool (e.g., PDF reader, word processor, etc.) to provide context information concerning a current project (e.g., 320) edited using the IDE 220 to the presentation tool (in this example, web browser 305). This context information (e.g., in the form of attribute data 245) may be used by a code sample adapter to allow code samples (e.g., 335) within various documents (e.g., webpage 330) provided by a wide array of sources (e.g., webpage hosting systems 120) to be automatically customized with project-specific modifications, such that the code sample (e.g., 335) is augmented within a GUI of a reader (e.g., web browser 305) to be more relevant to the current project 320 being developed by the user.

The manner in which a code sample adapter augments code samples may change depending on which coding project is determined to be “current” in a corresponding software development tool (e.g., IDE 220). In some implementations, a code project may be determined to be “current” based on the code of the project sample being worked on within a currently active or top window of a source code editor or other software development tool. In another example, the presence of an active text editing cursor within a source code editor's GUI may be interpreted (e.g., by a sample adapter engine) to indicate that the current code (and corresponding project) is the one currently worked on by a user. In some instances, it may not be a requirement that the current code be worked on contemporaneously with the user browsing code samples, in order to determine that the code (and corresponding code) are current. For instance, a particular one of the projects developed using a software development platform may be identified (e.g., by the code sample adapter) as the most recently edited or developed project, or a project may include a designation (e.g., entered by a corresponding user) that the project is to be considered the “current” project for purposes of adapting code samples found by the user (e.g., while the same user is logged-in within the software development project, browser, etc.), among other example implementations.

As noted above, a software development system implementing an enhanced IDE 220, as in the example of FIG. 3, may determine which of a number of coding projects is currently active or relevant (e.g., 320) to a particular user of the IDE 220. The IDE 220 may interface with a web browser 305 or other reader, which may be used to view documents (e.g., 330) including one or more code samples (e.g., 335). In some implementations, a plug-in (e.g., 310) may be provided, which may pull or receive attribute data (e.g., from the IDE 220 or other software development system components) corresponding to a currently active project (e.g., 320). The plug-in 310 may scan the webpage 330 and detect the presence of one or more code samples 335 and may further scan the code samples to determine whether the code samples include values (e.g., 340a,b) which may vary depending on the specific project. In some instances, the plug-in may further determine (e.g., from data provided by the IDE), whether the webpage 330 containing the code sample(s) (e.g., 330) are presented within the context of a user developing a particular project. For instance, if no project is determined to be “current” for the user viewing the page 330, the plug-in 310 (and corresponding code sample adapter) may simply allow the webpage 330 and its code samples (e.g., 335) to be presented in their native form (with variable values 340a-b in their default state). However, in instances where a current project 320 is detected as being edited or otherwise worked on by the user seeking to access and view the webpage 330, the plug-in 310 may intervene to cause the webpage's code samples (e.g., 3335) to be automatically modified to reflect the attributes of the current project 320.

Accordingly, the plug-in 310 or other components of a code sample adapter may cause the web browser 305 to replace detected variable values (e.g., 340a,b) within a webpage (e.g., 330) with project-specific values based on the attributes determined for the current project (e.g., 320) to generate a project-specific version of the code sample (e.g., 335). In some implementations, the project-variable values (e.g., 340a, 340b) may be values designated within the code sample itself (e.g., using markdown language, tags, or other designators) as being variable (or undefined within the code sample in recognition (by the author) of the variable nature of these values). In other instances, the project-variable values (e.g., 340a-b) may be identified based on mining of code (e.g., of other projects), which is similar to code presented within the code sample to identify values which vary from implementation-to-implementation, as well as the manner in which these values vary. For instance, a variable value may be the definition of a code variable or object in the code, which references an address of a particular system resource (e.g., a memory address, network address, database name, etc.) or a previously defined or named variable or method (e.g., which may be named differently in corresponding code components in the current project), among other example code terms, which may be entirely project- or system-specific. In another example, the variable value may have a constrained set of valid values, which may be pre-defined (e.g., as predefined within the syntax of the code's programming language, based on dependencies of the corresponding code (e.g., variables or functions of methods, objects, etc. referenced, called, or otherwise relied upon in the code component), among other examples, and the sample adapter (e.g., as implemented in the IDE 220, plug-in 310, or other system component) may determine which of the set of valid values is to be applied to the variable value based on the particular, current project 320. In yet other examples, functions, code constructs, conventions, and syntax of a particular programming language used within the code sample may be considered variable, in that these constructs (presented in the code sample) may be replaced by functionally-equivalent code of a different programming language used in the current project 320, allowing the code sample to be autonomously translated from the originally published programming language (in the original version of the code sample) to an equivalent version of the code sample in the programming language of the current project (e.g., to the extent a functional mapping may be defined between two language constructs), among other examples.

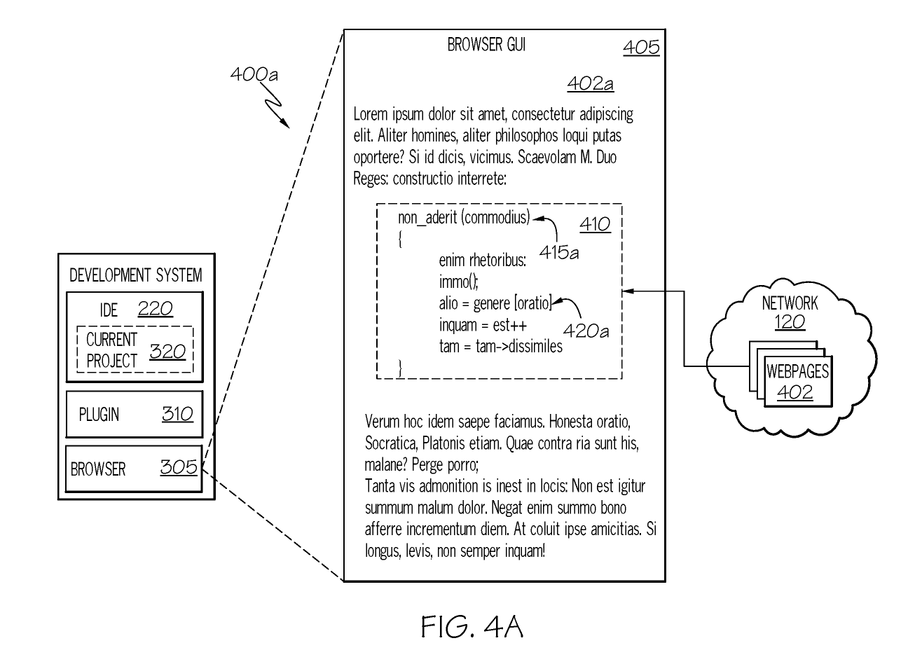

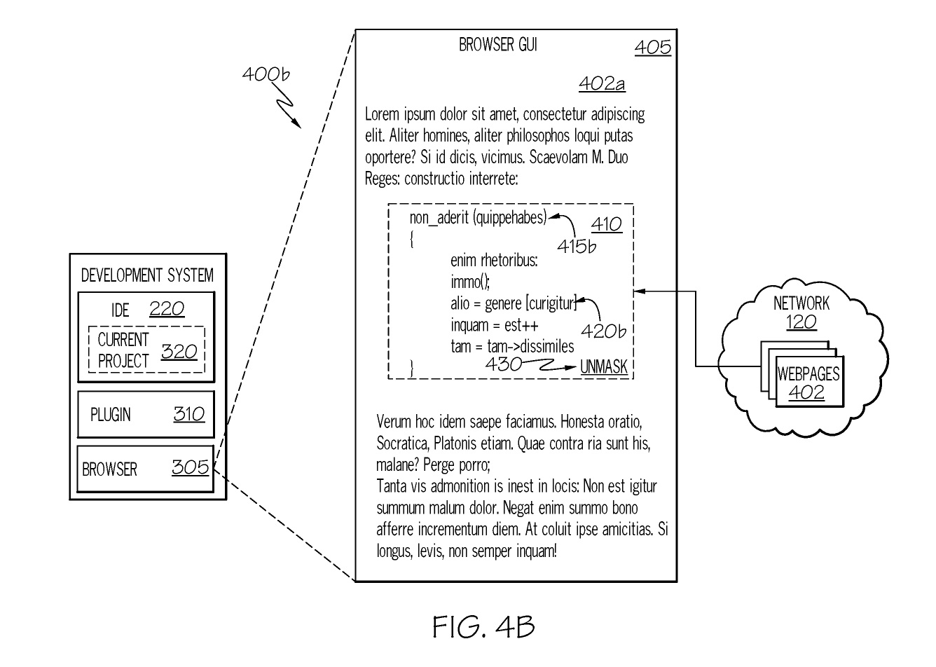

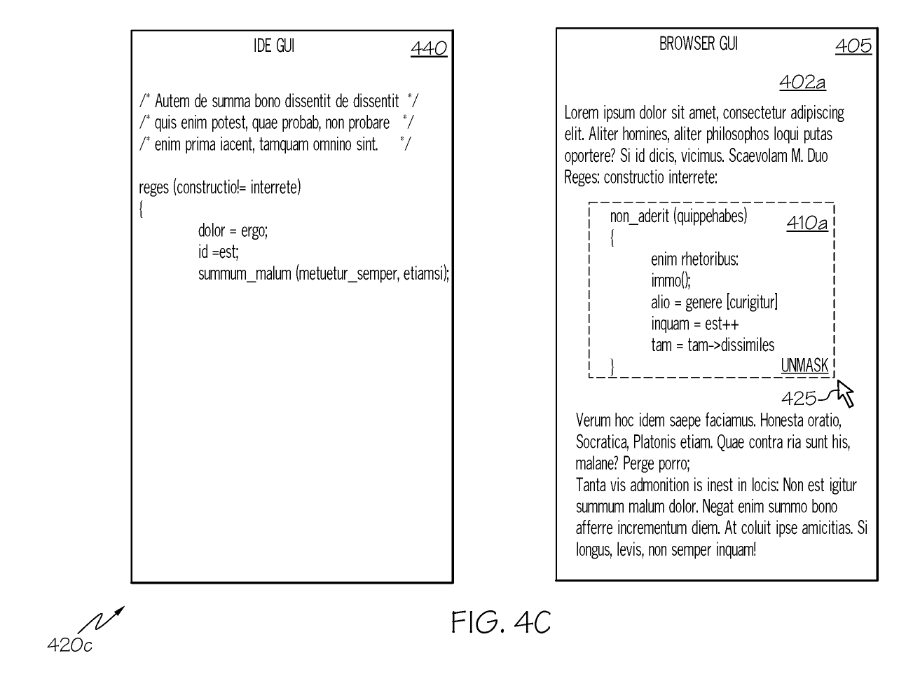

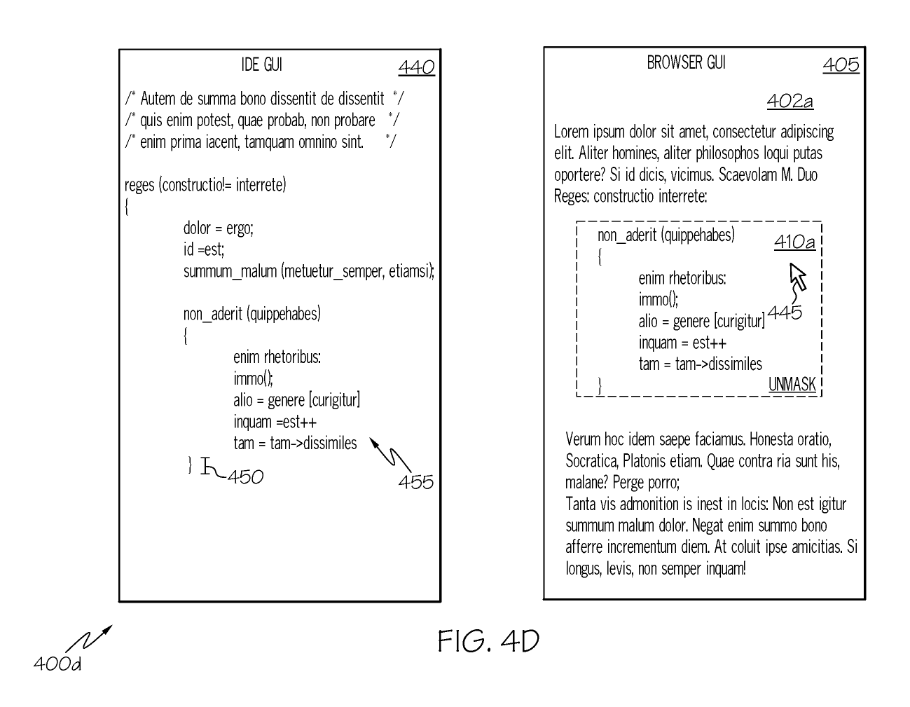

Turning to the examples of FIGS. 4A-4D, simplified block diagrams 400a-d are shown illustrating example adaptations of code samples augmented to generate project-specific versions of the code samples. For instance, in the example of FIG. 4A, a software development system may include an IDE 220, a browser 305 (or another electronic document reader), and a code sample adapter to enable an interface between a coding project editor (e.g., source code editor) of the IDE 220 and the reader (e.g., browser 305) and adapt content of code samples found in electronic documents to attributes of a coding project currently handled using the IDE 220. In this example, at least a portion of the code sample adapter may be implemented as a plugin 310 (e.g., to browser 305). The plugin 310 may detect that a user device (e.g., through browser 305) accesses one or more webpages 402 (e.g., hosted by one or more webservers in a network 120). The plugin 310 may additionally identify the contemporaneous (or otherwise corresponding) use of the IDE 220 to develop a particular coding project (e.g., 320). Based on this correlation, the plugin 310 may determine that the user's use of a browser 305 may be within the context of the user's use of IDE 220. Accordingly, when the plugin 310 detects content within an accessed webpage that corresponds to software development, such as the inclusion of code samples within the webpage (e.g., 402a), the plugin 310 may identify an opportunity to autonomously apply the context of the user's use of the IDE to the presentation of the webpage 402a including the code sample (e.g., 410), to customize the sample to the particular user and their coding project (e.g., 320).

In the example of FIG. 4A, a particular webpage may be requested (e.g., using browser 305 and corresponding network elements of the user's computer) to be presented within a GUI 405 of browser 305. The plugin 310 may scan content of the webpage 402a to determine that the page includes a potential code sample 410. In some cases, the code sample 410 may be explicitly designated within the webpage (e.g., 402a), such as through markdown language identifiers, explicit introduction of the sample (e.g., in other text of the webpage 402a, special formatting applied to the sample 410, etc.). In other cases, the plugin 310 may parse the content of the webpage 402a or provide the webpage 402a content as an input to a machine learning algorithm, or other automated technique to autonomously identify that a code sample (e.g., 410) is within the webpage document 402a, among other examples. Upon identifying the code sample (e.g., 410), the plugin 310 (or other code sample adapted logic) may analyze the code sample (e.g., using a machine parser to detect, parse, and interpret code within the code sample, using a trained machine learning model, through a model allowing comparison of the code with a corpus of other code components, etc.) to detect one or more values within code sample, which may be project-dependent values or values capable of being modified to reflect project-specific (e.g., to project 320) values.

In the example of FIG. 4A, sample 410 is analyzed to determine a set of project-variable values (e.g., 415a, 420a) within the original version of the sample 410. As noted above, project-variable values may be embodied as a variety of terms that may appear within source code of a project, such as a specifically named variable, a specific parameter or input that is used by a function, method, or object within the code, or even a programming-language specific function or construct, among other examples. In addition to identify that the sample 410 includes such project-variable values (e.g., 415a, 420a), the code sample adapter (e.g., based on a corpus of other code, including code segments related or similar to the code within the sample 410) may also determine how attributes of a specific project map to the project-variable values (e.g., 415a, 420a). For instance, based on a pattern detected within one or more other coding projects utilizing similar code, the code sample adapter may determine that particular project attributes (of project 320) map to the detected project-specific values 415a, 420a. Accordingly, as shown in the example of FIG. 4B, the code sample adapter (e.g., using plugin 310) may dynamically change, or mask, the values (e.g., 415a, 420a) as they would have been originally presented in the retrieved webpage 402a to values (e.g., 415b, 420b) corresponding to the current project's (and user context's) attributes. As shown in the example of FIG. 4B, the code sample may be presented as a modified, project-specific version (e.g., 410a) of the code sample within the webpage 402a. In some implementations, the modified version 410a may be formatted or include additional information presented with it in the browser GUI 405 to identify to the user that the presented version (e.g., 410a) of the code sample has been modified autonomously by the system (e.g., using its code sample adapter). In one example, as illustrated in FIG. 4B, a link or button may be added to the webpage 402a to indicate that the code sample has been modified and allow a user to selectively “unmask” the sample to reveal the original, default values included within the webpage's sample (e.g., as in version 410) to the user, to allow the user to appreciate and assess the accuracy of the suggested project-specific changes to the code sample, among other example considerations and implementations.

As shown noted above, in some implementations, a code sample adapter may autonomously adapt or translate one or more terms (or even an entire code sample) from a first programming language used in the original version of the code sample (e.g., 410) into a second, different programming language detected as being used in a current project (e.g., 320). Accordingly, in some implementations, a code sample adapter may make use of logic to determine functional constructs or abstractions of the code presented in a code sample (e.g., 410). Based on this determined functional abstraction, the code sample adapter may consult a language translation table or other data to determine, for the second programming language, functionally equivalent code that might replace the corresponding code offered in the first programming language within the original version of the code sample. As an example, code functions or other structures in one language (used in the sample) may be translated into a functional abstraction (e.g., an abstract syntax tree) and this may be used to map to functionally similar constructs in the language used in the subject coding project. For instance, the abstract syntax tree may be further converted to a universal syntax tree representation to identify language components in the target programming language. In some cases, user supervision data may be utilized to select from multiple potential target language constructs that map to the corresponding construct in the source (i.e., sample's) programming language, among other example techniques and implementations. Accordingly, using these and other example machine-automated techniques, the code sample adapter may translate one or more terms (which, in this sense, may be considered project-variable values) within the code of the first programming language into functionally equivalent code of the second programming language and present a modified, project-specific version of the code sample (e.g., 410a), which employs this programming language translation, among other examples.

Turning to the example of FIG. 4C, a modified code sample may be used conveniently, in some cases, with software development tools used to develop a corresponding coding project (e.g., 320). For instance, if a user, viewing the modified version of the code sample 410a, determines that all or a portion of the modified code sample could be of use within the code of the current project under development, the user may select the desired code within the modified code sample 410a and copy and paste the code within a GUI window (e.g., 440) of a source code editor used to edit the current project. For instance, as shown in FIG. 4D, the modified code sample may be selected (e.g., using a cursor 445 within the browser GUI 405), copy the modified code sample to a digital clipboard, and paste the modified code sample (e.g., at 455) directly within the source code editor GUI 440 (e.g., using text editor cursor 450) in connection with the development of the corresponding coding project.

As noted above, an example code sample adapter may consider user feedback when determining project-specific modifications, which might be accurately made to a default or original version of an example code sample. For instance, user feedback received after displaying a given project-specific modification to a code sample may be interpreted as either feedback that the system's autonomous modification of the code sample was inaccurate (and should be adjusted the next time a similar code sample is encountered by the code sample adapter), or as an endorsement or validation of the modification, such that similar modifications are adopted by the code sample adapter in future adaptations of the same or similar code samples. As demonstrated in the example illustrated in FIGS. 4C-4D, a user may copy and paste, or otherwise include code of a modified code sample (e.g., through manual typing/copying) into the source code of the current coding project. When project-specific code sample code is adopted, in this manner, by a user, within their own code, such an action may be detected by the code sample adapter (e.g., by virtue of its observations of both the IDE (e.g., 220) and browser (e.g., 305)) and may be interpreted by the code sample adapter as a ringing endorsement of the code sample adapter's modifications to the code sample. Such positive feedback may be utilized to support the code sample adapter's modifications of similar code samples in the future.

User feedback may also be detected by a code sample adapter in other instances. For example, a code sample adapter (or separate user feedback manager) may detect how a user interacts with the presentation of a modified version of a code sample (e.g., 410a) as generated by the code sample adapter and presented within a GUI (e.g., 405). For instance, upon presentation of a modified version (e.g., 410a) of a code sample, the code sample adapter or user feedback manager may detect that the user selects (e.g., using an unmask button 430) to unmask the modified values within the code sample to present the original version (e.g., 410) of the code sample to the user. The fact that the user elected to view the original version of the code sample may be interpreted, in some instances, as a form of negative feedback (e.g., and based on an assumption that the user elected to view the unmasked version based on a doubt that the presented modified version of the code sample was completely accurate. In some instances, additional buttons or interfaces may be presented in connection with a modified version of a code sample to allow a user to provide explicitly positive or negative feedback for the modified version of the code sample. For instance, such buttons may be provided in response to a user electing to unmask the modified version of the code sample. In still another example, a plugin or modified version of the browser or document viewer may allow users to suggest a correction to the modified version of the browser, for instance, through a user suggestion of alternative modifications to the code sample to bring the original version of the code sample into harmony with the specific attributes of the user's current project. Such user-provided suggested edits to the modified version of the code sample, may also be serve as feedback data, which may be used by the code sample adapter in future adaptation of similar code samples. In similar implementations, a source code adapter may also monitor the response of a user, in the user's use of a corresponding source code editor, to detect how the user uses the modified version 410a of a source code example presented to the user (e.g., in browser GUI 405). For instance, the source code adapter may identify that the user adopts a similar, but different, version of the presented version (e.g., 410) of the code sample in a source code editor GUI (e.g., GUI 440) after the modified code sample was displayed to the user (e.g., in GUI 405). The code sample adapter may detect a difference between the presented modified sample and the version of the code adopted by the user, and consider the difference as feedback, which the code sample editor considers and uses in subsequent adaptations of the code sample, among other example implementations.

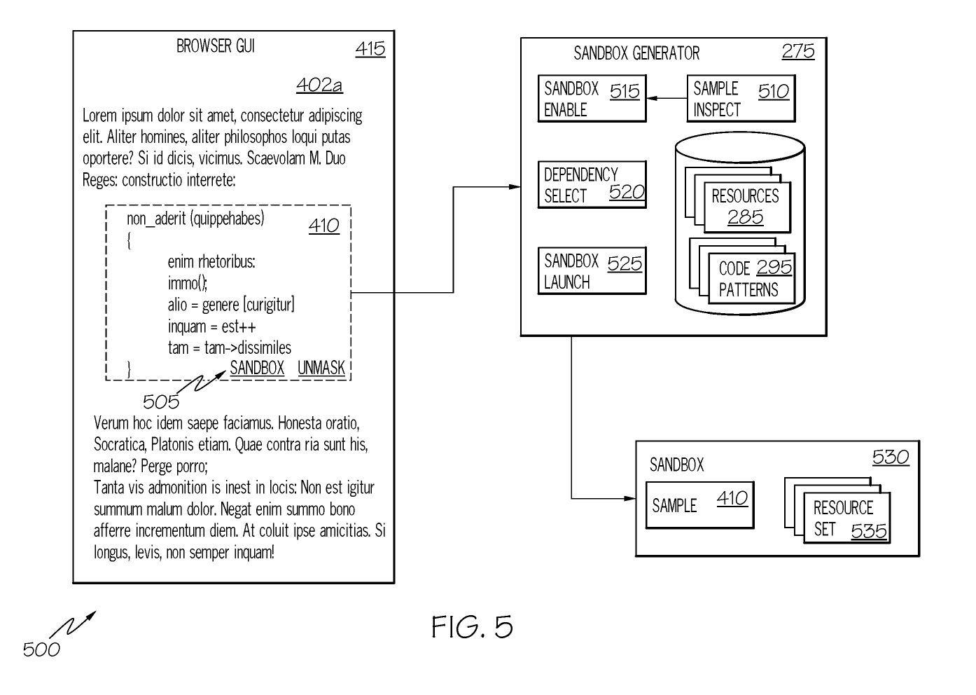

Turning to the example of FIG. 5, a simplified block diagram 500 is shown illustrating the autonomous instantiation of a sandbox execution environment 530 in response to detecting code samples 410 within example electronic documents (e.g., 402a). For instance, an example sandbox generator 275 (e.g., in connection with or independent from monitoring by a code sample adapter) may monitor use of an electronic document reader, such as web browser 415, to detect an electronic document (e.g., webpage 402a) accessed by a user using the document reader. Further, through the monitoring, one or more code samples may be autonomously identified within the webpage 402a. In some cases, a code sample adapter may automatically modify the code sample to adapt the sample to a current coding project detected as being worked on by the user, such as described in the examples above. Further, the detection of a code sample within a document may cause an example sandbox generator to assess the code represented within the code sample to instantiate a sandbox execution environment capable of executing the code within the sample and allow a user to test the sample code within the sandbox execution environment (e.g., 530).

In one example, a sandbox generator 275 may identify one or more code samples (e.g., 410a) within a webpage 402a. The sandbox generator 275 may inspect the identified code samples (e.g., using sample inspector 510), for instance, to determine the quality of the code (e.g., the detail of the code, whether the code is according to a defined programming language or pseudocode, etc.). Sample inspection 510 may involve determining similarities between the sample code and code described in code pattern data 295. For instance, the sandbox generator 275 may detect similarities between one or more code components (e.g., described in a depository) and the code sample, to identify patterns in the successful deployments of the sample's code (or in projects with code similar to the sample). Based on these similar coding projects, dependencies within the implementations of these similar coding projects may be determined to identify aspects of these implementation's respective execution environments that enable to the execution of the similar code within these projects. In some instances, depending on the results of the sample inspection 510, a sandbox generator 275 may determine whether it is possible to successfully deploy a sandbox environment for a particular code sample (e.g., using sandbox enabler 515). For instance, if the code sample is too informal, if inadequate code pattern data (e.g., 295) is identified which corresponds to the sample (e.g., 410), if the sandbox generator 275 lacks access to resources needed to build a successful sandbox for the identified code sample, or other issues are identified (e.g., by sandbox enabler 515), the sandbox enabler 515 may determine that the option to generate a corresponding sandbox execution environment be disabled for the code sample. Should the sandbox generator 275 determine that instantiation of a corresponding sandbox execution environment (e.g., 530) is possible for a given identified code sample, in some implementations, the sandbox generator 275 may cause an indicator or control (e.g., 505) to be presented with the code sample (e.g., 410). In such instances, a user may use the control 505 to cause the corresponding sandbox execution environment (e.g., 530) to be launched automatically to execute at least a portion of code in the code sample. In some cases, the code of the code sample may be modified code within a project-specific adaptation of a code sample, such as generated autonomously by a code sample adapter. In some cases, the adaptations made by the code sample adapter may cure issues with the code sample to allow the sandbox enabler (e.g., 515) to determine that a sandbox execution environment can be created for the modified code sample (e.g., even in cases where sandboxes for the original, unmodified version of the code sample may be determined by the sandbox enabler as not supported), among other examples.

In instances where the sandbox enabler 515 determines that a sandbox may be instantiated for a particular code sample (e.g., 410), the sandbox generator 275 may utilize results from the code inspector 510 (e.g., based on comparisons with other code components and projects described in code pattern data 295, etc.) to determine the system resources (e.g., platforms, methods, objects, libraries, etc.) upon which execution of the code sample's code are likely to be dependent. Accordingly, code dependency selection 520 may be utilized to determine various resources that correspond to these dependencies (e.g., accessible from a store of various resources 285, which may be used by the sandbox generator 275 to generate sandbox environments (e.g., 530)) for various code samples. The sandbox generator 275 may access and use these selected resources to generate a set of resources (e.g., 535) to be provided within a sandbox execution environment (e.g., 530), which is specifically built to provide the dependencies of the corresponding code sample code's execution. Indeed, a sandbox launcher 525 (e.g., in response to a request from a user to launch the sandbox) may launch the sandbox execution environment 530 (e.g., on the same or a different computing device implementing the sandbox generator 275) and may provide the code sample (e.g., 410) to the sandbox execution environment 530 for execution, among other example implementations.

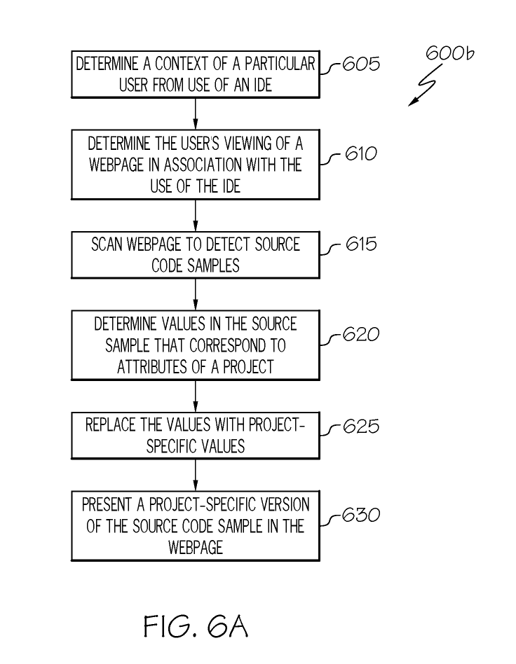

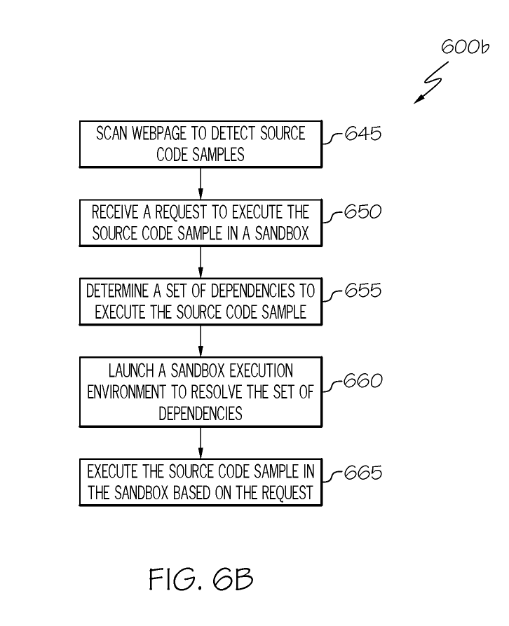

Turning to FIGS. 6A-6B, simplified flowcharts 600a-b are presented illustrating example techniques for enhancing code samples for presentation to users in graphical user interfaces. For instance, in the example of FIG. 6A, context of a particular user's attempt to access a particular webpage may be determined 605. The context may include determining a current coding project developed by the user and the attempt to access the webpage may be determined 610 to be associated with the webpage access. Data of the webpage may be scanned 615 to detect that the webpage includes one or more code samples. Values may be determined 620 through an analysis of the one or more code samples that may vary based on various attributes of the code's use within a particular coding project. Indeed, the values may be determined to correspond to particular attributes of the user's context and/or the current coding project detected as being associated with the attempt to access the webpage. These project-variable values determined (at 620) within the code sample may then be dynamically replaced 625 with project-specific values corresponding to the current coding project and a project-specific version of the source code sample(s) may be presented 630 in the webpage based on the determined context of the user.

Turning to the example of FIG. 6B, a webpage may be scanned 645 to detect one or more code samples within content of the webpage. A request may be received 650 from a user to execute code within a particular one of the code samples within a sandbox execution environment constructed to execute code of the particular code sample. In some cases, the sandbox execution environment may be automatically constructed in response to the detection of the corresponding particular code sample (e.g., 645). In other cases, system resources may be conserved such that sandboxes are only first constructed in response to receiving a request (e.g., at 650) to test or otherwise execute code within a particular code sample, among other example implementations. A set of dependencies of the particular code sample may be determined 655, for instance, based on an analysis of the particular code sample and comparison with implementations (e.g., in other systems) of the same or similar code within other coding projects. A sandbox execution environment corresponding to the particular code sample may then be constructed and launched 660 to include the determined dependencies. The launched sandbox execution environment may then be used to execute 665 the particular code sample based on the received request, among other example implementations and features.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
determining, using at least one data processing apparatus, that a particular software coding project is active in a particular session of a software development tool, wherein the software development tool is used to edit the particular software coding project during the particular session;
determining, using at least one data processing apparatus, a current context corresponding to the particular session, wherein the current context comprises attributes of the particular software coding project;
identifying a request to present a webpage in a web browser during the particular session, wherein the webpage is separate from the software development tool;
detecting, using at least one data processing apparatus, a segment of sample source code within content of the webpage, wherein the sample source code;
determining values in the segment of sample source code corresponding to the attributes of the particular software coding project using at least one data processing apparatus; and
replacing, using at least one data processing apparatus, the values in the segment of sample source code with project-specific values based on the request occurring during the particular session, wherein replacing the values causes a project-specific version of the segment of sample source code to be presented in the webpage during a session corresponding to the particular time, wherein the project-specific values are based on the attributes of the particular software coding project, and the sample source code comprises a sample of executable code.

2. The method of claim 1, wherein the values and project-specific values are determined based on a machine-recognized pattern recognized within a set of source code similar to the segment of sample source code.

3. The method of claim 2, further comprising:
determining a set of dependencies for successful execution of the segment of sample source code on a computer based on the pattern;
autonomously generating a sandbox environment comprising the set of dependencies;
receiving a user request to execute the segment of sample source code in the sandbox environment; and
executing the segment of sample source code in the sandbox environment.

4. The method of claim 3, further comprising:
determining whether a sandbox can be generated for the segment of sample source code; and
conditionally presenting a graphical user interface element for selection by the user to submit the user request based on determining that sandbox can be generated for the segment of sample source code.

5. The method of claim 1, wherein the values comprise code according to a syntax of a first programming language, the project-specific values comprise substitute value according to a syntax of a different second programming language, code of the particular software coding project comprises code in a particular programming language, the attributes comprises the particular programming language, and the particular programming language is different from the first programming language,
wherein determining the project-specific values comprises determining functional equivalents in the syntax of the second programming language for the syntax of the first programming language.

6. The method of claim 5, wherein the second programming language comprises the particular programming language.

7. The method of claim 5, wherein the second language comprises a programming language-neutral pseudocode.

8. The method of claim 1, wherein the attributes comprise addresses of resources used in the particular software coding project, the values comprise address information, and the project-specific values comprise one or more of the addresses of resources used in the particular software coding project.

9. The method of claim 1, wherein the project-specific attributes are determined based at least in part on user feedback by one or more other users received for one or more previous attempts to replace values in the segment of sample source code.

10. The method of claim 9, further comprising receiving user feedback from a particular user during the project-specific version of the segment of sample source code presented in the webpage during the session; and
supplementing the user feedback from the other users within the user feedback from the particular user to generate updated user feedback; and
replacing values in a subsequent presentation of a project-specific version of the segment based on the updated user feedback.

11. The method of claim 10, further comprising:
detecting a request, from a user, to unmask the values during presentation of the project-specific version of the segment of sample source code; and
unmasking the values to present an original version of the segment of sample source code, wherein the user feedback is received subsequent to unmasking the values.

12. The method of claim 9, further comprising:
detecting insertion of at least a portion of the project-specific version of the segment of sample source code within code of the particular software coding project;
generating positive feedback for the replacement of the values with the project-specific values based on the insertion, wherein the positive feedback supplements the user feedback to generate updated user feedback, and values in subsequent presentations of the segment are replaced based on the updated user feedback.

13. The method of claim 1, wherein the values in the segment of the sample source code are to be left presented unchanged when no software coding project is active in the software development tool.

14. The method of claim 1, wherein the software development tool comprises an integrated development environment (IDE)

15. The method of claim 1, wherein the software development tool comprises an interface with the browser to access data of the webpage, and the software development tool uses the data to determine the values in the segment of sample source code and cause the values to be replaced in the project-specific version of the segment of sample source code with the project-specific values.

16. The method of claim 15, wherein the software development tool comprises a web-based application and uses the browser as a graphical user interface (GUI).

17. A non-transitory computer readable medium having program instructions stored therein, wherein the program instructions are executable by a computer system to perform operations comprising:
determining that a particular software coding project is active in a particular session of an integrated development environment (IDE), wherein the particular session is associated with a particular user, and the IDE is used to edit the particular software coding project during the particular session;
determining that a particular webpage is accessed by a web browser during the particular session;
scanning the particular webpage to determine a segment of sample source code within content of the particular webpage;
determining values in the segment of sample source code corresponding to attributes of the particular software coding project; and
generating data for use by the web browser to generate a project-specific version of the segment of sample source code based on the particular webpage being presented within the particular session, wherein the project-specific version of the segment of the sample source code replaces the values with project-specific values based on the attributes of the particular software coding project, and the sample source code comprises a sample of executable code.

18. A system comprising:
a data processing apparatus;
a memory;
an integrated development environment (IDE) comprising a source code editor; and
a code sample adapter to interface with the IDE, wherein the code sample adapter is executable by the data processing apparatus to:
determine that a particular software coding project is active in a particular session of the IDE, wherein the particular session is associated with a particular user, and the IDE is used to edit the particular software coding project during the particular session;
determine that a particular webpage is accessed by a web browser during the particular session;
scan the particular webpage to determine a segment of sample source code within content of the particular webpage;
determine values in the segment of sample source code corresponding to attributes of the particular software coding project; and
generate data for use by the web browser to generate a project-specific version of the segment of sample source code based on the particular webpage being presented within the particular session, wherein the project-specific version of the segment of the sample source code replaces the values with project-specific values based on the attributes of the particular software coding project, and the sample source code comprises a sample of executable code.

19. The system of claim 18, further comprising a repository system comprising a corpus of source code project, wherein the values and project-specific values are determined based on a machine-recognized pattern within a subset of source code projects in the corpus comprising code similar to the segment of sample source code.

20. The system of claim 18, further comprising a sandbox engine, executable by the data processing apparatus to:
determine a set of dependencies for successful execution of the segment of sample source code on a computer based on the pattern;
autonomously generate a sandbox environment comprising the set of dependencies;
identify a user request to execute the segment of sample source code in the sandbox environment corresponding to the session; and
execute the segment of sample source code in the sandbox environment.
